(19) United States
(12) Patent Application Publication
(10) Pub. No.: US 2025/0103767 A1
(43) Pub. Date: Mar. 27, 2025

(54) Simulation Model Calibration Method and Apparatus

(71) Applicant: Siemens Aktiengesellschaft, München (DE)

(72) Inventors: Cheng Feng, Hangzhou (CN); Peng Wei Tian, Beijing (CN)

(73) Assignee: Siemens Aktiengesellschaft, München (DE)

(21) Appl. No.: 18/728,986

(22) PCT Filed: Jan. 29, 2022
(86) PCT No.: PCT/CN2022/075088

§ 371 Date: Jul. 15, 2024

(51) Int. Cl. G06F 30/20; G06F 119/02

(52) U.S. Cl. CPC G06F 30/20; G06F 2119/02

(57) ABSTRACT

Various embodiments of the teachings herein include a simulation model calibration method. For example, a method may include: obtaining prior distributions of at least two model parameters in a to-be-calibrated simulation model; obtaining a constraint condition of the at least two model parameters, wherein the constraint condition is used for indicating an association relationship between the model parameters; and performing at least one round of iteration on the at least two model parameters according to the prior distributions and the constraint condition, to obtain at least one parameter group applicable to the simulation model, wherein the parameter group comprises parameter values corresponding to the model parameters, and at least one model parameter corresponds to different parameter values in different parameter groups.

### CROSS-REFERENCE TO RELATED APPLICATIONS

This application is a U.S. National Stage Application of International Application No. PCT/CN2022/075088 filed Jan. 29, 2022, which designates the United States of America, the contents of which are hereby incorporated by reference in their entirety.

### TECHNICAL FIELD

This disclosure relates to computer technologies. Various embodiments of the teachings herein includes simulation model calibration methods and/or apparatus.

### BACKGROUND

Simulation models are models made to study simulated objects in a reliable, non-destructive, repeatable, safe, economical, and site-free manner, and simulation models are widely applied to the fields in national economy and social life. For example, energy consumption generated by heating, cooling, ventilation, and lighting of buildings can be studied by using building energy simulation models, thereby providing design guidance for energy-saving optimization strategies of buildings. A simulation model includes a plurality of model parameters, and values of the model parameters determine an output result of the simulation model, which affects the matching between the simulation model and a simulation object. To ensure the matching between the simulation model and the simulation object, it is necessary to perform model calibration on the simulation model, that is, to adjust the model parameters included in the simulation model.

Currently, during model calibration of the simulation model, the model parameters included in the simulation model are manually adjusted by modelers, until the matching degree between the simulation model and the simulation object reaches an expected target. However, because the simulation model includes a plurality of model parameters and there is a relationship between the model parameters, it may take a relatively long time to manually adjust the model parameters, resulting in relatively low efficiency of model calibration for the simulation model.

### SUMMARY

In view of this, this disclosure describes simulation model calibration methods and/or apparatus. For example, some embodiments of the teachings herein include a simulation model calibration method, including: obtaining prior distributions of at least two model parameters included in a to-be-calibrated simulation model; obtaining a constraint condition of the at least two model parameters, where the constraint condition is used for indicating an association relationship between the model parameters; and performing at least one round of iteration on the at least two model parameters according to the prior distributions and the constraint condition, to obtain at least one parameter group applicable to the simulation model, where the parameter group includes parameter values corresponding to the model parameters, and at least one model parameter corresponds to different parameter values in different parameter groups.

As another example, some embodiments include a simulation model calibration apparatus, including modules configured to perform operations in one or more of the simulation model calibration methods described herein.

As another example, some embodiments include an electronic device, including a processor, a communications interface, a memory, and a communications bus, where the processor, the memory, and the communications interface communicate with each other by using the communications bus, the memory is configured to store at least one executable instruction, and the executable instruction causes the processor to perform operations corresponding to one or more of the simulation model calibration methods described herein.

As another example, some embodiments include a computer-readable storage medium, where the computer-readable storage medium stores computer instructions, and the computer instructions, when executed by a processor, causes the processor to perform operations corresponding to one or more of the simulation model calibration methods described herein.

As another example, some embodiments include a computer program product, where the computer program product is tangibly stored on a computer-readable medium and includes computer executable instructions, and the computer executable instructions, when being executed, causes at least one processor to perform one or more of the simulation model calibration methods described herein.

### BRIEF DESCRIPTION OF THE DRAWINGS

FIG. 1 is a flowchart of an example simulation model calibration method incorporating teachings of the present disclosure;

FIG. 2 is a flowchart of an example simulation model calibration method incorporating teachings of the present disclosure;

FIG. 3 is a schematic diagram of an example simulation model calibration apparatus incorporating teachings of the present disclosure; and

FIG. 4 is a schematic diagram of an example electronic device incorporating teachings of the present disclosure.

### LIST OF REFERENCE NUMERALS

100: Simulation model 200: Simulation model calibration method calibration method
300: Simulation model 400: Electronic device calibration apparatus
301: First obtaining module 302: Second obtaining module 303: Iteration module
402: Processor 404: Communications interface 406 Memory
408: Communications bus 410: Program 101 to 103: Steps of method 100
201 to 214: Steps of method 200

### DETAILED DESCRIPTION

The prior distribution of a model parameter may indicate a basic distribution condition that the model parameter needs to satisfy, and a constraint condition between the model parameters may indicate an association relationship between the model parameters. That is, value ranges of the model parameters may be limited by the prior distributions and the constraint condition, so that the model parameters can be iterated according to the prior distributions and the constraint condition, to obtain at least one parameter group applicable to the simulation model by using reducing a difference between the output data of the simulation model and the observation data as an objective. Each parameter group includes parameter values corresponding to the model parameters of the simulation model, thereby implementing automatic calibration of the simulation model, compared with manually adjusting the parameters of the simulation model, which can not only reduce the requirements for professional knowledge, but also improve the efficiency of model calibration for the simulation model.

During building of a simulation model, to reduce a difference between a simulation result outputted by the simulation model and real observation data of a simulation object, the simulation model may be calibrated. Through adjusting a plurality of simulation parameters included in the simulation model, the matching between the simulation model and the simulation object is improved, thereby ensuring the accuracy of simulating the simulation object by using the simulation model. Currently, during calibration of the simulation model, the model parameters included in the simulation model are manually adjusted by modelers, thereby calibrating the simulation model. However, manually calibrating the simulation model requires the calibrator to have strong professional knowledge. Even an experienced calibrator needs a relatively long time to calibrate the simulation model to have an expected matching degree with the simulation object, which results in relatively low efficiency of model calibration for the simulation model.

According to the teachings of the present disclosure, during model calibration of a simulation model, prior distributions and a constraint condition of model parameters of the simulation model are first obtained. The prior distribution of the model parameter is used for indicating a basic distribution condition that the model parameter needs to satisfy, and the constraint condition between the model parameters may indicate an association relationship between the model parameters. Therefore, a plurality of rounds of iterations may be performed on the model parameters according to the prior distributions and the constraint condition, to obtain at least one parameter group applicable to the simulation model, and the parameter group includes parameter values corresponding to the model parameters of the simulation thereby model, implementing automatic calibration of the simulation model, compared with manually adjusting the parameters of the simulation model, which can not only reduce the requirements for professional knowledge, but also improve the efficiency of model calibration for the simulation model.

The following describes an example simulation model calibration method and apparatus, and an electronic device provided by the embodiments of this application in detail with reference to the accompanying drawings.

### Embodiment 1

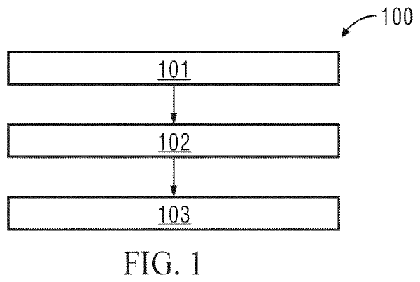

FIG. 1 is a flowchart of an example simulation model calibration method 100 incorporating teachings of the present disclosure. As shown in FIG. 1, the simulation model calibration method 100 includes the following:

Step 101: Obtain prior distributions of at least two model parameters included in a to-be-calibrated simulation model. The to-be-calibrated simulation model is a simulation model defined by a simulation model file, and the simulation model file may be generated by various types of simulation software. For example, when the simulation model is a simulation model for building energy consumption simulation, the to-be-calibrated simulation model may be generated by using a building energy consumption simulation engine EnergyPlus.

The simulation model generally includes a plurality of model parameters. Each model parameter included in the simulation model has an initial value, and the purpose of model calibration is to infer a reasonable value of each model parameter, so that the simulation model can accurately simulate a simulation object by using the inferred parameter values. The model parameters included in the simulation model may be defined by a parameter configuration file. The parameter configuration file defines names, acronyms, value ranges, and value types of the model parameters. The format of the parameter configuration file may be shown in Table 1 below.

TABLE 1

| Parameter | Parameter | Minimum | Maximum | |
|---|---|---|---|---|
| name | acronym | value | value | Value type |
| Model | A1 | 0 | 1 | Quantity of |
| parameter 1 | | | | floating points |
| Model | A2 | 2 | 100 | Integer |
| parameter 2 | | | | |
| . . . | . . . | . . . | . . . | . . . |

The prior distribution of the model parameter indicates a distribution that the model parameter satisfies before model calibration, and the prior distribution of the model parameter may be determined through the parameter configuration file. For example, a prior distribution of a model parameter 1 in Table 1 above is a uniform distribution between 0 and 1. Each model parameter has a corresponding prior distribution, and prior distributions of different model parameters may be the same or different.

Step 102: Obtain a constraint condition of the model parameters of the simulation model. The simulation model includes a plurality of model parameters, some or all of the model parameters may be related, and the constraint condition defines an association relationship among the model parameters. The constraint condition may be defined by a mathematical expression, for example, A1*A2<10. The mathematical expression indicates that a product of the model parameter 1 and a model parameter 2 is less than 10.

Step 103: Perform at least one round of iteration on the model parameters according to the prior distributions and the constraint condition of the model parameters, to obtain at least one parameter group applicable to the simulation model. Because the prior distribution defines a value range of one model parameter, and the constraint condition defines an association relationship between the model parameters, the model parameters may be iterated according to the prior distributions and the constraint condition of the model parameters, to gradually reduce a difference between an output result of the simulation model and observation data. At least one parameter group applicable to the simulation model can be obtained by performing a plurality of rounds of iterations on the model parameters. The parameter group includes parameter values corresponding to the model parameters, and at least one model parameter corresponds to different parameter values in different parameter groups.

The parameter group includes parameter values corresponding to the model parameters, which means that the parameter group includes parameter values of all model parameters included in the simulation model. For example, if the simulation model includes 50 model parameters, each parameter group includes parameter values corresponding to the 50 model parameters, that is, each parameter group includes 50 parameter values corresponding to different model parameters. At least one model parameter corresponds to different parameter values in different parameter groups, which means that for any two parameter groups, at least one model parameter in the two parameter groups corresponds to different parameter values.

For example, both a parameter group A and a parameter group B include parameter values corresponding to a model parameter 1 to a model parameter 50, the model parameter 1 corresponds to different parameter values in the parameter group A and the parameter group B, while the model parameter 2 to the model parameter 50 respectively corresponds to the same parameter values in the parameter group A and the parameter group B. In another example, the model parameter 1 and the model parameter 2 respectively corresponds to the same parameter values in the parameter group A and the parameter group B, while the model parameter 3 to the model parameter 50 correspond to different parameter values in the parameter group A and the parameter group B.

The observation data is a real observation result of the simulation object corresponding to the simulation model, and the output data of the simulation model is a prediction result of the simulation object based on the parameter values in the parameter group. A smaller difference between the observation data and the output data indicates better matching between the simulation model and the simulation object as well as a better effect of simulating the simulation object by the simulation model. For example, when the to-be-calibrated simulation model is a simulation model for building energy consumption simulation, the observation data is energy consumption of a building corresponding to the simulation model, and the output data is energy consumption of the building predicted by the simulation model based on model parameters such as room temperature and humidity.

In some embodiments, the prior distribution of the model parameter may indicate a basic distribution condition that the model parameter needs to satisfy, and the constraint condition between the model parameters may indicate an association relationship between the model parameters, that is, value ranges of the model parameters are limited by the prior distributions and the constraint condition, so that the model parameters can be iterated according to the prior distributions and the constraint condition, to obtain at least one parameter group applicable to the simulation model by using reducing a difference between the output data of the simulation model and the observation data as an objective, and each parameter group includes parameter values corresponding to the model parameters of the simulation model, thereby implementing automatic calibration of the simulation model, compared with manually adjusting the parameters of the simulation model, which can not only reduce the requirements for professional knowledge, but also improve the efficiency of model calibration for the simulation model.

### Embodiment 2

Based on the simulation model calibration method 100 provided in Embodiment 1, when iterations are performed on the model parameters according to the prior distributions and the constraint condition to obtain a parameter group, the parameter values of the model parameters may be sampled by using different sampling rules according to the quantity of iteration rounds. During a first round of iteration of the model parameters, sampling is sequentially performed from the prior distributions to obtain a sample including the parameter values corresponding to the model parameters, and for each obtained sample, the sample is determined as an accepted sample in the first round of iteration in a case that the sample satisfies preset screening conditions, until there are N accepted samples in the first round of iteration, where N is a positive integer.

In a t^{th} round of iteration of the model parameters, where t is a positive integer greater than 1, sampling is sequentially performed from N accepted samples in a (t−1)^{th} round of iteration, and random perturbation is performed on a sampled sample. If the sample after the random perturbation satisfies screening conditions, the sample after the random perturbation is determined as an accepted sample in the t^{th} round of iteration, until there are N accepted samples in the t^{th} round of iteration.

After a last round of iteration of the model parameters, N accepted samples in the last round of iteration are determined as N parameter groups of the simulation model.

In the first round of iteration of the model parameters, sampling is performed from the prior distributions of the model parameters, to obtain a sample including the parameter values of the model parameters. Whether the sample satisfies the preset screening conditions is then verified. If the sample satisfies the screening conditions, the sample is determined as an accepted sample in the first round of iteration, and if the sample does not satisfy the screening conditions, the foregoing sampling steps and sample screening steps are repeated, until there are N accepted samples in the first round of iteration.

In the t^{th} round of iteration of the model parameters, where t is a positive integer greater than or equal to 2, sampling is performed from the N accepted samples in the (t−1)^{th} round of iteration, and one accepted sample in the (t−1)^{th} round of iteration is sampled is a sample in the t^{th} round of iteration, and then random perturbation is performed on the sample. Whether the sample after the random perturbation satisfies the preset screening conditions is then verified. If the sample after the random perturbation satisfies the preset screening conditions, the sample after the random perturbation is determined as an accepted sample in the t^{th} round of iteration, and if the sample after the random perturbation does not satisfy the screening conditions, the foregoing sampling steps and the sample screening steps are repeated, until there are N accepted samples in the t^{th} round of iteration.

For a sample θ* sampled from the N accepted samples in the (t−1)^{th} round of iteration, random perturbation may be performed on the sample by using a perturbation kernel implemented through Gaussian random walk, to obtain a sample θ** after the random perturbation. Whether the sample θ** satisfies the preset screening conditions is then verified. If the sample θ** satisfies the preset screening conditions, the sample θ** is determined as an accepted sample in the t^{th} round of iteration; otherwise, the sample θ** is discarded, and sampling is performed from the N accepted samples in the (t−1)^{th} round of iteration again. The process of performing random perturbation on the sample θ* by using the perturbation kernel implemented based on Gaussian random walk, to obtain the sample θ** may be expressed by θ**˜Kₜ(θ|θ*).

N is a preset sample quantity, for example, N may be 5, 10, 20, 40, or the like. After the last round of iteration of the model parameters is completed, the N accepted samples in the last round of iteration are all determined as parameter groups applicable to the simulation model, and a total of N parameter groups may be obtained. According to a sampling rule of sampling from N accepted samples in a penultimate round of iteration and random perturbation on sampled samples, at least one model parameter corresponds to different parameter values in different parameter groups in the obtained N parameter groups.

In this embodiment, in the first round of iteration of the model parameters, sampling is performed from the prior distributions of the model parameters, and in each round of iteration after the first round of iteration, sampling is performed from the accepted samples in the previous round of iteration, and random perturbation is performed on the sampled samples to generate new samples. Through such a sampling method, a plurality of rounds of iterations can be performed on the model parameters of the simulation model, thereby ensuring that model calibration can be implemented through iterative optimization. Through sampling from the accepted samples in the previous round of iteration and performing random perturbation on the sampled samples to generate new samples, the parameter values of the model parameters can be continuously optimized, thereby ensuring that the simulation model can accurately simulate the simulation object when using parameter groups finally obtained.

In a possible implementation, the screening conditions may include the following condition (i) and condition (ii) or condition (i) and condition (iii):
(i) parameter values in a target sample conform to the prior distributions and the constraint condition of the model parameters, where the target sample includes a sample sampled from the prior distributions or a sample after the random perturbation;
(ii) it is determined, according to at least one latest reference sample, that a probability that a distance deviation corresponding to the target sample is less than a tolerance value corresponding to a current iteration round is greater than a preset probability threshold, where the reference sample is a sample once used by the simulation model during running, a distance deviation corresponding to a sample is used for indicating a distance between output data during use of the sample by the simulation model and observation data, and the observation data is an observation result of a simulation object corresponding to the simulation model; and
(iii) the distance deviation corresponding to the target sample is less than the tolerance value corresponding to the current iteration round.

For the condition (i), after the target sample is sampled from the prior distributions of the model parameters or obtained by performing random perturbation on accepted samples in a previous round of iteration, whether the target sample conforms to the prior distributions and the constraint condition is verified. If the target sample simultaneously conforms to the prior distributions and the constraint condition, it is determined that the target sample satisfies the condition (i), and if the target sample does not conform to the prior distributions or the constraint condition, it is determined that the target sample does not satisfy the condition (i).

In the first round of iteration of the model parameters, because the sample is sampled from the prior distributions, the sample conforms to the prior distributions. Therefore, it is only necessary to verify whether the sample satisfies the constraint condition. If the sample satisfies the constraint condition, it can be determined that the sample satisfies the condition (i).

For the condition (ii), after determination that the target sample satisfies the condition (i), it is verified, according to at least one latest reference sample, that whether a probability that the distance deviation corresponding to the target sample is less than the tolerance value corresponding to the current iteration round is greater than the preset probability threshold. If the probability that the distance deviation corresponding to the target sample is less than the tolerance value corresponding to the current iteration round is greater than the probability threshold, it is determined that the target sample satisfies the condition (ii). In this case, because the target sample satisfies the condition (i) and the condition (ii), the target sample can be determined as an accepted sample in the current iteration round.

If a probability that the distance deviation corresponding to the target sample is greater than the tolerance value corresponding to the current iteration round is greater than the probability threshold, it is determined that the target sample does not satisfy the condition (ii). In this case, the target sample is directly discarded, and sampling is performed from the prior distributions or accepted samples in a previous iteration round again.

If the probability that the distance deviation corresponding to the target sample is less than the tolerance value corresponding to the current iteration round is less than the probability threshold, and the probability that the distance deviation corresponding to the target sample is greater than the tolerance value corresponding to the current iteration round is less than the probability threshold, it cannot be determined, through the condition (ii), whether to accept the target sample as an accepted sample in the current iteration round, and determination is further performed through the condition (iii).

The reference sample is a sample once used by the simulation model during running, that is, a sample is configured to the simulation model, and after the simulation model runs based on the sample, the sample becomes a reference sample. Because the simulation model is run based on parameter values included in only one sample at a time, the at least one latest reference sample is a plurality of samples that have been configured to the simulation model recently for running. The reference sample may be an accepted sample or a rejected sample. Because the simulation model has been run based on the reference sample, output data of the simulation model during running based on the reference sample can be obtained, so that a distance deviation corresponding to the reference sample can be obtained.

For the condition (iii), when it cannot be determined, through the condition (ii), whether to accept the target sample as an accepted sample in the current iteration round, the simulation model uses the target sample for running, to obtain output data of the simulation model. The distance deviation corresponding to the target sample is calculated according to the output data of the simulation model and the observation data, and it is then verified whether the calculated distance deviation is less than the tolerance value corresponding to the current iteration round. If the calculated distance deviation is less than the tolerance value corresponding to the current iteration round, the target sample is determined as an accepted sample in the current iteration round, and if the calculated distance deviation is greater than the tolerance value corresponding to the current iteration round, the target sample is discarded, and sampling is performed from the prior distributions or accepted samples in a previous iteration round again.

The distance deviation is used for indicating a difference between the output data of the simulation model and the observation data, and the distance deviation may be a Euclidean distance, a dynamic time warping (DTW) distance, or the like between the output data and the observation data. In addition, in the condition (ii), the probability that the distance deviation is greater than the tolerance value is predicted, and the distance deviation does not need to be calculated, while in condition (iii), output data of the simulation model needs to be obtained after the target sample is allocated to the simulation model, and a distance deviation between the output data and the observation data needs to be calculated.

In the condition (ii), whether the probability that the distance deviation corresponding to the target sample is less than the tolerance value corresponding to the current iteration round is greater than the probability threshold needs to be predicted according to a plurality of latest reference samples, and the latest reference samples may be samples verified in the same iteration round or may be samples verified in different iteration rounds. If the quantity of latest reference samples does not meet a requirement for the quantity of reference samples, the verification of the condition (ii) is skipped and whether the target sample satisfies the condition (iii) is directly verified.

In this embodiment, in the condition (ii), through a plurality of latest reference samples, the probability that the distance deviation corresponding to the target sample is less than the tolerance value corresponding to the current iteration round and the probability that the distance deviation corresponding to the target sample is greater than the tolerance value corresponding to the current iteration round are predicted. If the probability that the distance deviation corresponding to the target sample is less than the tolerance value corresponding to the current iteration round greater than the preset probability threshold, the target sample is directly determined as an accepted sample in the current iteration round.

If the probability that the distance deviation corresponding to the target sample is greater than the tolerance value corresponding to the current iteration round is greater than the preset probability threshold, the target sample is directly discarded and sampling is performed again, so that the output data of the simulation model is obtained without configuring all samples to the simulation model, thereby saving the time for running the simulation model based on parameter values of model parameters in the samples, shortening the time required for iterating the model parameters, and improving the efficiency of calibrating the simulation model.

In some embodiments, during verification of whether the target sample satisfies the condition (ii), a distance probability distribution that can indicate a relationship between a reference sample and a corresponding distance deviation may be fitted according to a distance deviation corresponding to at least one latest reference sample, and the probability that the distance deviation corresponding to the target sample is less than the tolerance value corresponding to the current iteration round is then determined according to the distance probability distribution and compared with the preset probability threshold. If the probability that the distance deviation corresponding to the target sample is less than the tolerance value corresponding to the current iteration round is greater than the probability threshold, it is determined that the target sample satisfies the condition (ii).

The distance probability distribution corresponding to the target sample θ** is P(d|θ**, θ,d), where θ is used for representing a matrix formed by n latest reference samples, d is used for representing a vector formed by distance deviations corresponding to the n latest reference samples, and n is the quantity of reference samples predetermined for fitting the distance probability distribution. If P(d<ϵₜ|θ**, θ,d)>α, the target sample θ** is determined as an accepted sample in the current iteration round, if P(d>ϵₜ|θ**, θ,d)>α, the target sample θ** is discarded and sampling is performed again, and if P(d<ϵₜ|θ**, θ,d)≤α and P(d>ϵₜ|θ**, θ, d)≤α, it is necessary to verify whether the target sample θ** satisfies the above condition (iii), where ϵₜ is used for representing the tolerance value corresponding to the current iteration round, and α is used for representing the preset probability threshold.

In the distance probability distribution P(d|θ**, θ,d), the target sample θ** is an m-dimensional vector, m is the quantity of model parameters included in the simulation model, each dimension included in the target sample θ** corresponds to a parameter value of one model parameter, θ is a matrix including n θ, θ is an m-dimensional vector, each θ corresponding to a reference sample, m dimensions included in θ are m parameter values included in the corresponding reference sample, d is an n-dimensional vector, and each dimension included in d is a distance deviation corresponding to one latest reference sample. The latest n reference samples are newly determined n reference samples relative to a current time.

In this embodiment, the distance probability distribution is fitted according to the plurality of latest reference samples, which is essentially fitting a Gaussian process regression model. A distribution of the distance deviation between the output data of the simulation model and the observation data is estimated by using the Gaussian process regression model, so that whether to accept the target sample can be quickly determined without configuring the target sample to the simulation model for running, thereby saving the time required for iterating the model parameters of the simulation model, and improving the efficiency of calibrating the simulation model.

In some embodiments, during verification of whether the target sample satisfies the above condition (ii), it is necessary to determine the probability that the distance deviation corresponding to the target sample is less than the tolerance value corresponding to the current iteration round. It can be learned that different iteration rounds may correspond to different tolerance values. A tolerance value corresponding to the first round of iteration is a preset initial tolerance value, and a tolerance value corresponding to the t^{th} round of iteration is determined according to distance deviations corresponding to the N accepted samples in the (t−1)^{th} round of iteration.

In some embodiments, the preset initial tolerance value is ϵ₀, and the tolerance value corresponding to the t^{th} round of iteration is calculated through the following formula: ϵₜ=ρ* median({dₜ₋₁}), where ϵᵢ is used for representing the tolerance value corresponding to the t^{th} round of iteration, {dₜ₋₁} is used for representing a set of N distance deviations corresponding to the N accepted samples determined in the (t−1)^{th} round of iteration, median( [symbol] ) is a median operator, ρ is a shrinkage factor of the tolerance value, and ρϵ(0,1].

In this embodiment, a tolerance value corresponding to the current round of iteration is determined according to N accepted samples determined in a previous round of iteration. Specifically, a product of a median of distance deviations corresponding to the N accepted samples determined in the previous round of iteration and the shrinkage factor may be used as the tolerance value corresponding to the current round of iteration. Because the shrinkage factor is greater than 0 and less than or equal to 1, the tolerance value gradually decreases with the increase of the quantity of iteration rounds, so that a deviation between the output data of the simulation model and the observation data is reduced, thereby obtaining N parameter groups applicable to the simulation model through gradual optimization, and ensuring that the simulation model can be quickly and accurately calibrated.

In some embodiments, during sampling from the N accepted samples in the (t−1)^{th} round of iteration, sampling may be performed from the N accepted samples in the (t−1)^{th} round of iteration according to weights respectively corresponding to the N accepted samples in the (t−1)^{th} round of iteration. A weight corresponding to an accepted sample is used for indicating a probability that the accepted sample is selected in a next round of iteration, the N accepted samples in the first round of iteration have the same weights, and weights of N accepted samples in the t^{th} round of iteration are determined according to posterior distributions of the model parameters after the t^{th} round of iteration and the weights of the N accepted samples in the (t−1)^{th} round of iteration.

After a round of iteration is completed, weights corresponding to N accepted samples in the round of iteration are determined for sampling from N accepted samples in a next round of iteration according to the weights corresponding to the accepted samples in the round of iteration. After the first round of iteration is completed, the weights of the N accepted samples in the first round of iteration are all set to 1. After the t^{th} round of iteration is completed, a weight corresponding to a t^{th} accepted sample in the t^{th} round of iteration is calculated through the following formula:

$${w}_{t}^{( i )} = \frac{P ( {θ}_{t}^{( i )} )}{{\sum }_{j = 1}^{N} {w}_{t - 1}^{( j )} {K}_{t} ( {θ}_{t - 1}^{( j )} \vert {θ}_{t}^{( i )} )}$$

where wₜ⁽ⁱ⁾ is used for representing a weight corresponding to an i^{th} accepted sample in the t^{th} round of iteration, P(θᵢ⁽ⁱ⁾) is used for representing a posterior distribution satisfied by the i^{th} accepted sample in the t^{th} round of iteration, wₜ₋₁^{(j)} is used for representing a weight corresponding to a j^{th} accepted sample in the (t−1)^{th} round of iteration, and Kₜ(θₜ₋₁^{(j)}|θₜ⁽ⁱ⁾) is used for representing a perturbation kernel used during generation of the i^{th} accepted sample in the t^{th} round of iteration through random perturbation.

In this embodiment, after each round of iteration is ended, weights of accepted samples in this round of iteration are determined according to posterior distributions of the model parameters in this round of iteration and weights corresponding to N accepted samples in a previous round of iteration, and sampling is performed in a next round of iteration from the N accepted samples in this round of iteration according to the weights corresponding to the accepted samples in this round of iteration, so that a value range of each model parameter of the simulation model can converge faster to reduce the quantity of iteration rounds of the model parameters, shorten the time required for calibrating the simulation model, and improve the efficiency of model calibration for the simulation model.

In some embodiments, during iteration of the model parameters of the simulation model, the quantity of iteration rounds or the magnitude of the tolerance value may be used as a trigger condition for ending the iteration. For example, the quantity of iteration rounds is preset, for example, the quantity of iteration rounds is set to 100. When the quantity of iteration rounds of the model parameters reaches the preset quantity of iteration rounds, the iteration of the model parameters is ended, and N accepted samples in the last round of iteration are determined as N parameter groups applicable to the simulation model. In another example, the tolerance value gradually decreases with the increase of the quantity of iteration rounds. A smaller tolerance value indicates a smaller distance deviation between the output data of the simulation model during use of the accepted samples and the observation data as well as a higher accuracy of simulating the simulation object by the simulation model. Therefore, a tolerance threshold may be set. When the tolerance value is less than or equal to the tolerance threshold, the iteration of the model parameters is ended, and the N accepted samples in the last round of iteration are determined as N parameter groups applicable to the simulation model.

### Embodiment 3

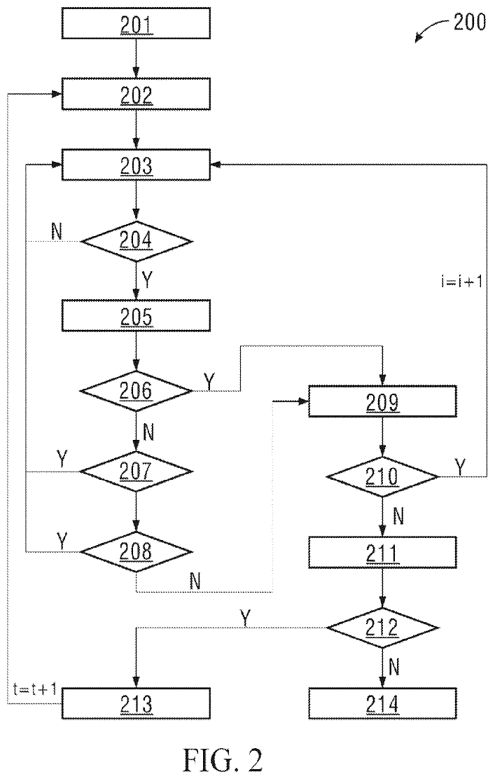

An example simulation model calibration method incorporating teachings of the present disclosure is described in detail with reference to a specific example. As shown in FIG. 2, the example simulation model calibration method 200 includes the following steps:

Step 201: Set parameters N,T,ρ,ϵ₀,ϵ, n and α, and set t to 0. The parameter N is used for representing the quantity of accepted samples that need to be determined for each round of iteration of model parameters. T is used for representing a preset maximum quantity of iteration rounds. ρ is used for representing a preset tolerance value shrinkage factor, and pϵ(0,1]. ϵ₀ is used for representing a tolerance value corresponding to a first round of iteration. ϵ is used for representing a target tolerance value. n is used for representing the quantity of latest reference samples used during fitting of a Gaussian regression model. α is used for representing a probability threshold. t is used for representing the quantity of completed iteration rounds of the model parameters.

In an example, N=20, T=100, ρ=0.8, ϵ₀=80, ϵ=10, n=10, and α=0.8.

Step 202: Set i to 1. i is used for representing the quantity of accepted samples determined in a current round of iteration.

Step 203: Obtain a sample θ** through sampling. If t=0, that is, the current round of iteration is the first round of iteration, and independent sampling is performed from prior distributions of the model parameters to obtain the sample θ**.

If t>0, that is, the current round of iteration is an iteration after the first round of iteration, θ* is sampled from N accepted samples {θₜ₋₁⁽ⁱ⁾} in a (t−1)^{th} round of iteration based on weights Wₜ₋₁ corresponding to the N accepted samples in the (t−1)^{th} round of iteration, perturbation is performed on the sample θ* by using a perturbation kernel Kₜ implemented based on Gaussian random walk, and Gaussian noise is added to the sample θ* to obtain a sample θ**, where the process of performing perturbation on the sample θ* to obtain the sample θ** may be marked as θ**˜Kₜ(θ|θ*).

Step 204: Detect whether θ** conforms to the prior distributions and a constraint condition, if yes, perform step 205, and if no, perform step 203. After the sample θ** is obtained, it is verified whether the sample θ** conforms to the prior distributions and the constraint condition of the model parameters in a simulation model. If the sample θ** does not conform to the prior distributions, that is, P(θ**)=0, or the sample θ** does not conform to the constraint condition of the model parameters, the process returns to step 203 and sampling is performed again. If the sample θ** conforms to both the prior distributions and the constraint condition, step 205 is performed.

Step 205: Estimate a probability distribution of a distance deviation between output data corresponding to the sample θ** and observation data through a Gaussian process. A Gaussian process is fitted by using n latest reference samples, to estimate the probability distribution of the distance deviation between the output data of the simulation model during use of the sample θ** and the observation data, where the reference samples are samples once used and run by the simulation model. The probability distribution may be represented by P(d|θ**, θ,d), where θ is used for representing a matrix formed by the n latest reference samples, d is used for representing a vector formed by distance deviations corresponding to the n latest reference samples, d is the distance deviation between the output data of the simulation model during use of the sample θ** and the observation data.

Step 206: Determine whether P(d<ϵₜ|θ**, θ,d)>α is valid, if yes, perform step 209, and if not, perform step 207. After the probability distribution P(d|θ**,θ,d) of the distance deviation between the output data corresponding to the sample θ** and the observation data is obtained, it is verified whether P(d<ϵₜ|θ**, θ,d)>α is valid, where ϵₜ is used for representing a tolerance value corresponding to a t^{th} round of iteration. If P(d<ϵₜ|θ**, θ, d)>α is valid, step 209 is performed, and if not, step 207 is performed.

Step 207: Determine whether P(d>ϵₜ|θ*, θ,d)>α is valid, if yes, perform step 203, and if not, perform step 208. It is verified whether P(d>ϵₜ|θ**, θ,d)>α is valid. If yes, the sample θ** is discarded, the process returns to step 203, and sampling is performed again, and if not, step 208 is performed.

Step 208: Determine whether d(x,x*)>ϵₜ is valid, if yes, perform step 203, and if not, perform step 209. The parameter values of the model parameters of the simulation model are replaced with parameter values included in the sample θ**, and the simulation model is then run to obtain the output data x of the simulation model. Next, the distance deviation d(x,x*) between the output data x and the observation data x* is calculated, and whether d(x,x*)>ϵₜ is valid is verified. If d(x,x*)>ϵₜ is valid, the sample θ** is discarded, the process returns to step 203, and sampling is performed again, and if not, step 209 is performed.

Step 209: Determine the sample θ** as an accepted sample in the t^{th} round of iteration and calculate a weight corresponding to the sample θ**. θₜ⁽ⁱ⁾=θ** is set, θ** is determined as an i^{th} accepted sample in the t^{th} round of iteration, and a weight corresponding to θₜ⁽ⁱ⁾ is calculated through the following formula:

$${w}_{t}^{( i )} = \{ \begin{matrix}1 , if t = 0 \\ \frac{P ( {θ}_{t}^{( i )} )}{{\sum }_{j = 1}^{N} {w}_{t - 1}^{( j )} {K}_{t} ( {θ}_{t - 1}^{( j )} \vert {θ}_{t}^{( i )} )} , if t > 0\end{matrix}$$

That is, during the first round of iteration, the weight wₜ⁽ⁱ⁾ corresponding to the accepted sample θₜ⁽ⁱ⁾ is set to 1, and in each round of iteration after the first round of iteration, the weight wₜ⁽ⁱ⁾ corresponding to the accepted sample θₜ⁽ⁱ⁾ is set to

$$\frac{P ( {θ}_{t}^{( i )} )}{{\sum }_{j = 1}^{N} {w}_{t - 1}^{( j )} {K}_{t} ( {θ}_{t - 1}^{( j )} \vert {θ}_{t}^{( i )} )} .$$

Step 210: Determine whether i<N is valid, if yes, execute i=i+1, and perform step 203; and if not, perform step 211. After the sample θ** is determined as an accepted sample in the t^{th} round of iteration, it is verified whether i<N is valid. If i<N is valid, it indicates that the quantity of accepted samples in the t^{th} round of iteration does not reach N, and an (i+1)^{th} accepted sample needs to be determined. Therefore, after i=i+1 is executed, the process returns to step 203. If i<N is not valid, that is, i=N, it indicates that there has been N accepted samples in the t^{th} round of iteration, there is no need to determine another accepted sample in the t^{th} round of iteration, and step 211 is correspondingly performed.

Step 211: Normalize weights of the N accepted samples in the t^{th} round of iteration.

Step 212: Determine whether t<T or ϵₜ>ϵ is valid, if yes, perform step 213, and if not, perform step 214. If t<T or ϵₜ>ϵ is valid, it indicates that it is necessary to continue to iterate the model parameters of the simulation model, and step 213 is performed correspondingly. If t<T or ϵₜ>ϵ is not valid, that is, t≥T and ϵₜ≤ϵ, it indicates that the trigger condition of ending the iteration is satisfied, and iteration does not need to be performed on the model parameters of the simulation model, and step 214 is performed correspondingly.

Step 213: Calculate a tolerance value corresponding to the (t+1)^{th} round of iteration, and perform step 202 after t=t+1 is executed. The tolerance value ϵₜ₊₁ corresponding to the (t+1)^{th} round of iteration is calculated through the following formula:

$${ϵ}_{t + 1} = ρ * median ( \{ {d}_{t} \} )$$

where {dₜ} is used for representing a set formed by distance deviations corresponding to the N accepted samples in the t^{th} round of iteration.

Step 214: Obtain N parameter groups applicable to the simulation model. The set {θₜ⁽ⁱ⁾} formed by the N accepted samples in the t^{th} round of iteration is obtained. Each accepted sample included in the set {θₜ⁽ⁱ⁾} is determined as a parameter group applicable to the simulation model, so that N parameter groups applicable to the simulation model are determined.

It should be noted that, In the simulation model calibration method provided by the foregoing embodiments, after a plurality of parameter groups applicable to the simulation model are obtained, output data for each parameter group may be obtained after parameter values included in each parameter group are configured to the simulation model, a probability distribution of output data of the simulation model then can be determined according to the output data for each parameter group, and the simulation object can be more accurately simulated according to the probability distribution.

### Embodiment 4

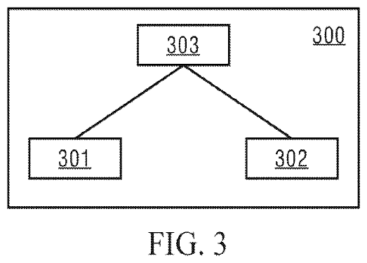

Embodiment 4 of this application provides an example simulation model calibration apparatus. The apparatus includes modules configured to perform operations in the foregoing method embodiments. FIG. 3 is a schematic diagram of a simulation model calibration apparatus 300 according to Embodiment 4 of this application. As shown in FIG. 3, the simulation model calibration apparatus 300 includes:
a first obtaining module 301, configured to obtain prior distributions of at least two model parameters included in a to-be-calibrated simulation model;
a second obtaining module 302, configured to obtain a constraint condition of the at least two model parameters, where the constraint condition is used for indicating an association relationship between the model parameters; and
an iteration module 303, configured to perform at least one round of iteration on the at least two model parameters according to the prior distributions and the constraint condition, to obtain at least one parameter group applicable to the simulation model, where the parameter group includes parameter values corresponding to the model parameters, and at least one model parameter corresponds to different parameter values in different parameter groups.

In this embodiment, the first obtaining module 301 may be configured to perform step 101 in Embodiment 1, the second obtaining module 302 may be configured to perform step 102 in Embodiment 1, and the iteration module 303 may be configured to perform step 103 in Embodiment 1.

In some embodiments, the iteration module 303 is configured to perform the following operations:
sequentially sampling from the prior distributions in a first round of iteration of the at least two model parameters, to obtain a sample including the parameter values corresponding to the model parameters, and determining the sample as an accepted sample in the first round of iteration in a case that the sample satisfies preset screening conditions, until there are N accepted samples in the first round of iteration, where N is a positive integer;
sequentially sampling from N accepted samples in a (t−1)^{th} round of iteration in a t^{th} round of iteration of the at least two model parameters, performing random perturbation on a sampled sample, and determining the sample after the random perturbation as an accepted sample in the t^{th} round of iteration in a case that the sample after the random perturbation satisfies the screening conditions, until there are N accepted samples in the t^{th} round of iteration, where t is a positive integer greater than 1; and
determining N accepted samples in a last round of iteration of the at least two model parameters as N parameter groups of the simulation model.

In some embodiments, the screening conditions include the following condition (i) and condition (ii) or condition (i) and condition (iii):
(i) parameter values in a target sample conform to the prior distributions and the constraint condition, where the target sample includes a sample sampled from the prior distributions or a sample after the random perturbation;
(ii) it is determined, according to at least one latest reference sample, that a probability that a distance deviation corresponding to the target sample is less than a tolerance value corresponding to a current iteration round is greater than a preset probability threshold, where the reference sample is a sample once used by the simulation model during running, a distance deviation corresponding to a sample is used for indicating a distance between output data during use of the sample by the simulation model and observation data, and the observation data is an observation result of a simulation object corresponding to the simulation model; and
(iii) the distance deviation corresponding to the target sample is less than the tolerance value corresponding to the current iteration round.

In some embodiments, the iteration module 303 is further configured to perform the following operations:
fitting a distance probability distribution according to a distance deviation corresponding to the at least one reference sample, where the distance probability distribution is used for indicating a relationship between the reference sample and the corresponding distance deviation;
determining, according to the distance probability distribution, the probability that the distance deviation corresponding to the target sample is less than the tolerance value corresponding to the current iteration round; and
determining that the target sample satisfies the condition (ii) in a case that the probability that the distance deviation corresponding to the target sample is less than the tolerance value corresponding to the current iteration round is greater than the probability threshold.

In some embodiments, a tolerance value corresponding to the first round of iteration of the at least two model parameters is a preset initial tolerance value, and a tolerance value corresponding to the t^{th} round of iteration of the at least two model parameters is determined according to distance deviations corresponding to the N accepted samples in the (t−1)^{th} round of iteration.

In some embodiments, the iteration module 303 is configured to sequentially sample from the N accepted samples in the (t−1)th round of iteration according to weights respectively corresponding to the N accepted samples in the (t−1)^{th} round of iteration, where a weight corresponding to an accepted sample is used for indicating a probability that the accepted sample is selected in a next round of iteration, the N accepted samples in the first round of iteration have the same weights, and weights of the N accepted samples in the t^{th} round of iteration are determined according to posterior distributions of the at least two model parameters after the t^{th} round of iteration and the weights of the N accepted samples in the (t−1)^{th} round of iteration.

Content such as information exchange and an execution process between the modules in the simulation model calibration apparatus is based on a same idea as the foregoing embodiments of the simulation model calibration method. Therefore, for details, refer to descriptions in the foregoing embodiments of the simulation model calibration method, and details are not described herein again.

### Embodiment 5

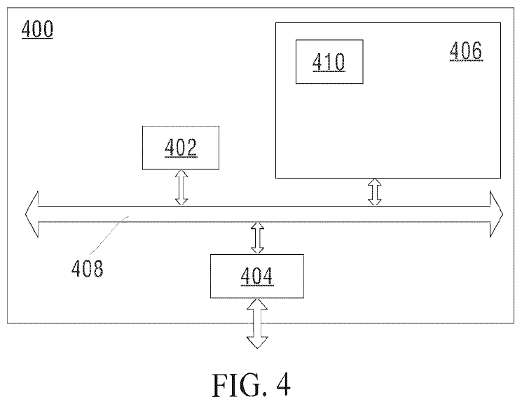

FIG. 4 is a schematic diagram of an example electronic device 400 according to Embodiment 5. A specific implementation of the electronic device is not limited to the specific embodiments described herein. Referring to FIG. 4, the electronic device 400 includes a processor 402, a communications interface 404, a memory 406, and a communications bus 408. The processor 402, the communications interface 404, and the memory 406 communicate with each other by using the communications bus 408.

The communications interface 404 is configured to communicate with another electronic device or server.

The processor 402 is configured to execute a program 410 and may further perform related steps in any one of the foregoing embodiments of the simulation model calibration method. Specifically, the program 410 may include program code, and the program code includes a computer operating instruction.

The processor 402 may be a central processing unit (CPU) or an application specific integrated circuit (ASIC) or may be configured as one or more integrated circuits for implementing the embodiments of this application. One or more processors included in a smart device may be the same type of processors, such as one or more CPUs, or may be different types of processors, such as one or more CPUs and one or more ASICs.

The memory 406 is configured to store the program 410. The memory 406 may include a high-speed random access memory (RAM), or may further include a non-volatile memory, for example, at least one magnetic disk storage.

The program 410 may be further configured to cause the processor 402 to perform the simulation model calibration method in any one of the foregoing embodiments.

For specific implementations of the program 410, reference may be made to the corresponding descriptions in the corresponding steps and units in any one of the foregoing embodiments of the simulation model calibration method, and details are not described herein again. It may be clearly understood by a person skilled in the art that, for the purpose of convenient and brief description, for a detailed working process of the foregoing device and modules, reference may be made to corresponding process descriptions in the foregoing method embodiments, and details are not described herein again.

By using one of the electronic devices described herein, the prior distribution of the model parameter may indicate a basic distribution condition that the model parameter needs to satisfy, and the constraint condition between the model parameters may indicate an association relationship between the model parameters, that is, value ranges of the model parameters are limited by the prior distributions and the constraint condition, so that the model parameters can be iterated according to the prior distributions and the constraint condition, to obtain at least one parameter group applicable to the simulation model by using reducing a difference between the output data of the simulation model and the observation data as an objective, and each parameter group includes parameter values corresponding to the model parameters of the simulation model, thereby implementing automatic calibration of the simulation model, compared with manually adjusting the parameters of the simulation model, which can not only reduce the requirements for professional knowledge, but also improve the efficiency of model calibration for the simulation model.

### Embodiment 6

Some embodiments include a computer-readable storage medium storing instructions used for making a machine to perform one or more of the simulation model calibration methods described herein. Specifically, a system or an apparatus that is equipped with a storage medium stores software program code that implements functions of any one of the embodiments, and a computer (a CPU or an MPU) of the system or the apparatus is enabled to read and execute the program code stored in the storage medium.

In this case, the program code read from the storage medium can implement the functions in any one of the foregoing embodiments, and therefore the program code and the storage medium for storing the program code constitute a part of this application.

Embodiments of the storage medium for providing the program code may include a floppy disk, a hard disk, a magneto-optical disk, an optical memory (such as a CD-ROM, a CD-R, a CD-RW, a DVD-ROM, a DVD-RAM, a DVD-RW, and a DVD+RW), a magnetic tape, a non-volatile storage card, and a ROM. Optionally, the program code may be downloaded from a server computer by using a communication network. Moreover, it should be clear that an operating system operated in the computer can be made, not only by executing program code read by a computer, but also by using an instruction based on the program code, to implement some or all actual operations, so as to implement functions of any one of the foregoing embodiments.

In addition, it can be understood that the program code read from the storage medium may also be written to a memory that is disposed in an extension board inserted in the computer, or may be written to a memory that is disposed in an extension module connected to the computer, and then a CPU or the like that is installed on the extension board or extension module may be enabled to execute some or all actual operations based on instructions of the program code, so as to implement the functions of any one of the foregoing embodiments.

### Embodiment 7

Some embodiments of the teachings herein include a computer program product stored on a tangible non-transitory computer-readable medium and includes computer executable instructions, and the computer executable instructions, when being executed, causes at least one processor to perform the simulation model calibration method provided in the foregoing embodiments. It should be understood that the solutions in this embodiment have the corresponding technical effects in the above method embodiments, and details are not described herein again.

Not all steps and modules in the procedures and the system structure diagrams are necessary, and some steps or modules may be omitted according to an actual requirement. An execution sequence of the steps is not fixed and may be adjusted according to requirements. The system structure described in the embodiments may be a physical structure or a logical structure.

That is, some modules may be implemented by the same physical entity, or some modules may be implemented by a plurality of physical entities or may be implemented by some components in a plurality of independent devices together.

In some embodiments, the hardware modules may be implemented mechanically or electrically. For example, a hardware module may include a permanent dedicated circuit or logic (for example, a dedicated processor, FPGA or ASIC) to complete a corresponding operation. The hardware module may further include programmable logic or a circuit (for example, a general-purpose processor or another programmable processor), which may be temporarily set by software to complete a corresponding operation. A specific implementation (a mechanical manner, a dedicated permanent circuit, or a temporarily set circuit) may be determined based on costs and time considerations.

This application is shown and described in detail in the above through the accompanying drawings and example embodiments. However, the scope of the disclosure is not limited to the disclosed embodiments. Based on the above embodiments, a person skilled in the art may learn that simulation model calibration methods in different embodiments may be combined to obtain more embodiments of this application, and these embodiments also fall within the protection scope.

What is claimed is:

1. A simulation model calibration method comprising:
obtaining prior distributions of at least two model parameters in a to-be-calibrated simulation model;
obtaining a constraint condition of the at least two model parameters, wherein the constraint condition is used for indicating an association relationship between the model parameters; and
performing at least one round of iteration on the at least two model parameters according to the prior distributions and the constraint condition, to obtain at least one parameter group applicable to the simulation model, wherein the parameter group comprises parameter values corresponding to the model parameters, and at least one model parameter corresponds to different parameter values in different parameter groups.

2. The method according to claim 1, wherein performing at least one round of iteration on the at least two model parameters according to the prior distributions and the constraint condition comprises:
sequentially sampling from the prior distributions in a first round of iteration of the at least two model parameters, to obtain a sample comprising the parameter values corresponding to the model parameters, and determining the sample as an accepted sample in the first round of iteration in a case that the sample satisfies preset screening conditions, until there are N accepted samples in the first round of iteration, wherein N is a positive integer;
sequentially sampling from N accepted samples in a (t−1)^{th} round of iteration in a t^{th} round of iteration of the at least two model parameters, performing random perturbation on a sampled sample, and determining the sample after the random perturbation as an accepted sample in the t^{th} round of iteration in a case that the sample after the random perturbation satisfies the screening conditions, until there are N accepted samples in the t^{th} round of iteration, wherein t is a positive integer greater than 1; and
determining N accepted samples in a last round of iteration of the at least two model parameters as N parameter groups of the simulation model.

3. The method according to claim 2, wherein the screening conditions comprise the following condition (i) and condition (ii) or condition (i) and condition (iii):
(i) parameter values in a target sample conform to the prior distributions and the constraint condition, wherein the target sample comprises a sample sampled from the prior distributions or a sample after the random perturbation;
(ii) it is determined, according to at least one latest reference sample, that a probability that a distance deviation corresponding to the target sample is less than a tolerance value corresponding to a current iteration round is greater than a preset probability threshold, wherein the reference sample is a sample once used by the simulation model during running, a distance deviation corresponding to a sample is used for indicating a distance between output data during use of the sample by the simulation model and observation data, and the observation data is an observation result of a simulation object corresponding to the simulation model; and
(iii) the distance deviation corresponding to the target sample is less than the tolerance value corresponding to the current iteration round.

4. The method according to claim 3, further comprising: fitting a distance probability distribution according to a distance deviation corresponding to the at least one reference sample, wherein the distance probability distribution is used for indicating a relationship between the reference sample and the corresponding distance deviation;
determining, according to the distance probability distribution, the probability that the distance deviation corresponding to the target sample is less than the tolerance value corresponding to the current iteration round; and
determining that the target sample satisfies the condition (ii) in a case that the probability that the distance deviation corresponding to the target sample is less than the tolerance value corresponding to the current iteration round is greater than the probability threshold.

5. The method according to claim 2, wherein the sequentially sampling from N accepted samples in a (t−1)^{th} round of iteration comprises
sequentially sampling from the N accepted samples in the (t−1)^{th} round of iteration according to weights respectively corresponding to the N accepted samples in the (t−1)^{th} round of iteration, wherein a weight corresponding to an accepted sample is used for indicating a probability that the accepted sample is selected in a next round of iteration, the N accepted samples in the first round of iteration have the same weights, and weights of the N accepted samples in the t^{th} round of iteration are determined according to posterior distributions of the at least two model parameters after the t^{th} round of iteration and the weights of the N accepted samples in the (t−1)^{th} round of iteration.

6. (canceled)

7. An electronic device comprising:
a processor;
a communications interface;
a memory; and
a communications bus providing communication between the processor, the memory, and the communications interface;
the memory stores at least one executable instruction, and the executable instruction causes the processor to perform operations including:
obtaining prior distributions of at least two model parameters in a to-be-calibrated mulation model;
obtaining a constraint condition of the at least two model parameters, wherein the constraint condition used for indicating an association relationship between the model parameters; and
performing at least one round of iteration on the at least two model parameters according to the prior distributions and the constraint condition, to obtain at least one parameter group applicable to the simulation model, wherein the parameter group comprises parameter values Corresponding to the model parameters, and at least one model parameter corresponds to different parameter values in different parameter groups.

8-9. (canceled)
